(19) United States
(12) Patent Application Publication
(10) Pub. No.: US 2025/0388254 A1
(43) Pub. Date: Dec. 25, 2025

(54) Folding Stroller

(71) Applicant: NINGBO BEICHI BABY PRODUCTS CO., LTD., Ningbo (CN)

(72) Inventor: Fangliang Weng, Ningbo (CN)

(21) Appl. No.: 18/932,683

(22) Filed: Oct. 31, 2024

(30) Foreign Application Priority Data
Jun. 24, 2024 (CN) 202421453702.0

(51) Int. Cl. B62B 7/06; B62B 9/08

(52) U.S. Cl. CPC B62B 7/064; B62B 9/082

(57) ABSTRACT

The disclosure relates to a folding stroller, and relates to the field of strollers, including a front frame, a rear frame, a folding mechanism configured for connecting the front frame and the rear frame, a set of front wheels mounted to the front frame and a set of rear wheels mounted to the rear frame; the rear wheel includes a connecting base, a wheel body and a brake mechanism; the brake mechanism includes a brake turntable and a pedal member configured for cooperating with the brake turntable; a plurality of brake grooves are circumferentially spaced apart from the brake turntable; and the pedal has a brake projection inserted into the brake groove. The disclosure can improve the braking effect of the wheels in the folding stroller and has a more ideal structural strength.

### CROSS REFERENCE TO RELATED APPLICATIONS

The present application claims the benefit of Chinese Patent Application No. 202421453702.0 filed on Jun. 24, 2024. All the above are hereby incorporated by reference in their entirety.

### TECHNICAL FIELD

The disclosure relates to the field of strollers, and more particularly to a folding stroller.

### BACKGROUND ART

Outdoor folding cart is a common outdoor device used in the camping and picnic. It can not only be used to place items to facilitate the storage and transportation of items, but also part of outdoor folding cart may be used as a temporary baby carriage for infants. It can temporarily place an infant in the folding cart and reduce the probability of infants having an accident in the open air.

The folding stroller includes a folding frame and a wheel assembly mounted on the folding frame. The folding frame includes a front frame, a rear frame, and a folding mechanism connected between the front frame and the rear frame. The front frame and the rear frame are generally rectangular frames connected by metal pipes. In order to facilitate the movement of the folding stroller, the upper part of the rear frame is generally provided with a push-pull handle. The wheel assembly includes a set of front wheels mounted to the front frame and a set of rear wheels mounted to the rear frame. The front wheel or the rear wheel is usually provided with a braking structure. An abutment block is usually used in the existing braking structure to abut against the wheel, thereby locking the wheel to achieve the purpose of braking.

With regard to the above-mentioned related art, the inventor has considered that the braking effect of the above-mentioned braking structure with which the folding stroller has abutment and is locked is not ideal.

### SUMMARY OF THE INVENTION

In order to improve the braking effect of the wheels in the folding stroller, the disclosure provides a folding stroller.

The disclosure provides a folding stroller with the following technical solution.

A folding stroller includes a front frame, a rear frame, a folding mechanism configured for connecting the front frame and the rear frame, a set of front wheels mounted to the front frame and a set of rear wheels mounted to the rear frame, wherein the rear wheel includes a connecting base mounted to the rear frame, a wheel body rotatably mounted to the connecting base, and a brake mechanism configured for restricting rotation of the wheel body; the brake mechanism includes a brake turntable fixed to the wheel body, and a pedal member slidably mounted up and down on the connecting base and configured for cooperating with the brake turntable; a plurality of brake grooves are circumferentially spaced apart from the brake turntable; the pedal member has a brake projection inserted into the brake groove; the pedal member is slidably mounted up and down on the connecting base and has a braking position and an unlocking position; the brake projection is inserted into the brake groove when the pedal member is in a braking position; and the brake projection is located outside the brake turntable when the pedal member is in the unlocking position.

Optionally, a positioning structure configured for positioning the pedal member in the braking position and the unlocking position is further provided between the pedal member and the connecting base; the positioning structure includes a positioning hole formed on the pedal member, a ball plunger mounted in the positioning hole, and a drive spring configured for driving the ball plunger to move in the direction of the connecting base at all times, a locking groove formed on the connecting base and configured for cooperating with the ball plunger, and an unlocking groove formed on the connecting base and configured for cooperating with the ball plunger; the pedal member is in the braking position when the ball plunger is inserted into the locking groove; and the pedal member is in the unlocking position when the ball plunger is inserted into the unlocking groove.

Optionally, the connecting base has sliding through grooves arranged up and down; the pedal member includes an outer pedal and an inner pedal mounted inside the outer pedal; the outer pedal has a pedal slider slidably arranged in the sliding through groove; and the brake projection is arranged on the inner pedal.

Optionally, the rear frame includes at least two frame units and a reinforcing beam connected to the frame units; the frame unit includes a first upright tube, a second upright tube located on a front side of the first upright tube, and a locking clamp configured for locking the first upright tube and the second upright tube; the reinforcing beam has a welding block corresponding to the frame unit and configured for connecting and fixing the first upright tube and the second upright tube, the welding block being located between the first upright tube and the second upright tube; the locking clamp is arranged on both upper and lower sides of the welding block; the locking clamp includes a first locking portion and a second locking portion; the first locking portion has a first through hole configured for arranging the first upright tube, and the first locking portion and the first upright tube are locked by screws; and the second locking portion has a second through hole configured for arranging the second upright tube.

Optionally, the first upright tubes are each provided with a first holder, and a first link rod being connected between adjacent first holders; and the second upright tubes are each provided with a second holder, and a second link rod is connected between adjacent second holders.

Optionally, the number of the frame units in the rear frame is two, two of the frame units being located on both sides of the rear frame; and the rear wheel is mounted to a bottom end of the first upright tube.

Optionally, the connecting base includes a fixed seat mounted to the first upright tube and a wheel carrier rotatably cooperating with the fixed seat; a limiting seat is provided at a front end of the wheel carrier, and the limiting seat is provided with a limiting hole for inserting the second upright tube; a gap exists between the inner wall of the limiting hole and the outer wall of the second upright tube; and the maximum deflection angle of the rear wheel is not greater than ±6°.

Optionally, the rear frame is further provided with a push-pull handle, both ends of which are provided with a handle sleeve arranged corresponding to the first upright tube; and the handle sleeve is sleeved on a top end of the corresponding first upright tube.

Optionally, the number of folding mechanisms provided between the front frame and the rear frame is two groups, which are a first folding mechanism and a second folding mechanism located on a lower side of the first folding mechanism, respectively; and an overturning bracket configured for supporting the inside of the cloth cover is rotatably mounted on both sides of the first folding mechanism.

Optionally, the first folding mechanism includes a first turnover frame and a second turnover frame which is turnover and folded up and down in cooperation; one end of the first turnover frame is turnover and folded up and down and mounted to the front frame; and the second turnover frame is turnover and folded up and down and mounted to the rear frame.

Optionally, the second folding mechanism includes two sets of folding link rods arranged opposite to each other in a left and right direction; the folding link rods includes a first folding rod, a second folding rod and an articulated frame, one end of the first folding rod being rotatably mounted on the front frame and the other end being articulated to the articulated frame; and one end of the second folding rod is rotatably mounted on the rear frame and the other end is articulated to the articulated frame.

Optionally, the second folding mechanism includes two sets of telescopic link rods arranged opposite to each other in the left and right direction, the telescopic link rods including a first telescopic link rod and a second telescopic link rod; one end of the first telescopic link rod is rotatably mounted on the front frame, and the other end has a telescopic hole into which the second telescopic link rod extends; and one end of the second telescopic link rod facing away from the first telescopic link rod is rotatably mounted on the rear frame.

In summary, the disclosure includes at least one of the following beneficial technical effects.
1. The above-mentioned folding stroller is provided with a brake structure at the rear wheel, which is different from a traditional abutting and locking structure. The brake structure cooperates with the brake projection and the brake groove of the brake turntable so as to lock the rear wheel, so that the wheel body of the rear wheel does not rotate. The reliability of the above-mentioned brake structure and the braking effect are ideal.
2. The above-mentioned folding stroller forms a spatial three-dimensional frame structure by arranging the rear frame to have at least two frame units and the reinforcing beam. The structural strength of the rear frame is improved and the probability that the rear frame of the folding stroller is deformed during the transportation of bearing goods is reduced by limiting the number of locking clamps to be at least two, locating the locking clamp at the upper and lower sides of the welding block, and further connecting the first link rod to the adjacent first upright tube, and further connecting the second link rod to the adjacent second upright tube.
3. By the cooperation of the second upright tube in the rear frame and the limiting seat on the rear wheel, the deflection angle of the rear wheel is limited, so that it is easier for a user to push the above-mentioned rear frame reinforced folding stroller and the travel route is more accurate.

### BRIEF DESCRIPTION OF THE DRAWINGS

FIG. 1 is a schematic view of a folding stroller according to Example 1 of the disclosure.

FIG. 2 is a schematic view of a rear frame cooperated with rear wheels according to Example 1 of the disclosure.

FIG. 3 is a schematic view of a locking clamp according to Example 1 of the disclosure.

FIG. 4 is a schematic view of a first reinforcing link rod according to Example 1 of the disclosure.

FIG. 5 is a schematic view of a second reinforcing link rod according to Example 1 of the disclosure.

FIG. 6 is an exploded view showing the cooperation of the rear wheel and a first upright rod according to Example 1 of the disclosure.

FIG. 7 is a schematic view of a locking member according to Example 1 of the disclosure.

FIG. 8 is a schematic cross-sectional view of the rear wheel according to Example 1 of the disclosure.

FIG. 9 is a positioning structure between a connecting base and a pedal member according to Example 1 of the disclosure.

FIG. 10 is a schematic view of a second folding mechanism according to Example 1 of the disclosure.

FIG. 11 is a schematic view of a first folding rod, a second folding rod and an articulated frame according to Example 1 of the disclosure.

FIG. 12 is a schematic view of a first folding structure according to Example 1 of the disclosure.

FIG. 13 is an exploded view showing the cooperation of the first folding rod and a front upright rod according to Example 1 of the disclosure.

FIG. 14 is an enlarged partial view at A in FIG. 12.

FIG. 15 is a schematic view showing the unfolded structure of the folding stroller according to Example 2 of the disclosure.

FIG. 16 is a schematic view of a second folding mechanism according to Example 2 of the disclosure.

FIG. 17 is an enlarged partial view at B in FIG. 16.

FIG. 18 is a schematic view showing the folded structure of the folding stroller according to Example 2 of the disclosure.

### DETAILED DESCRIPTION OF THE INVENTION

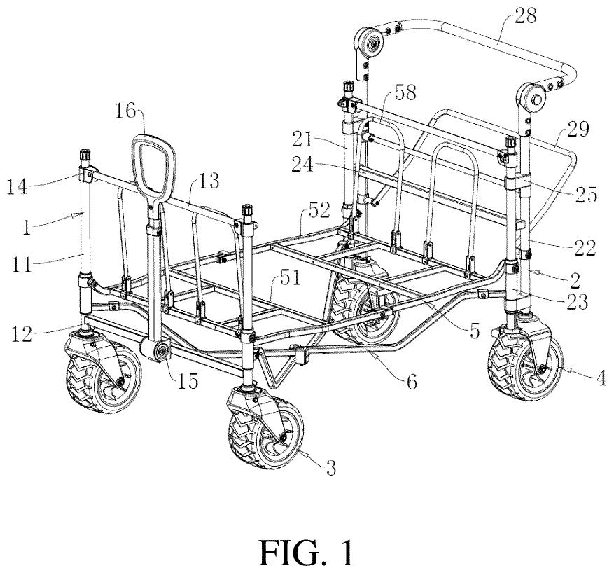

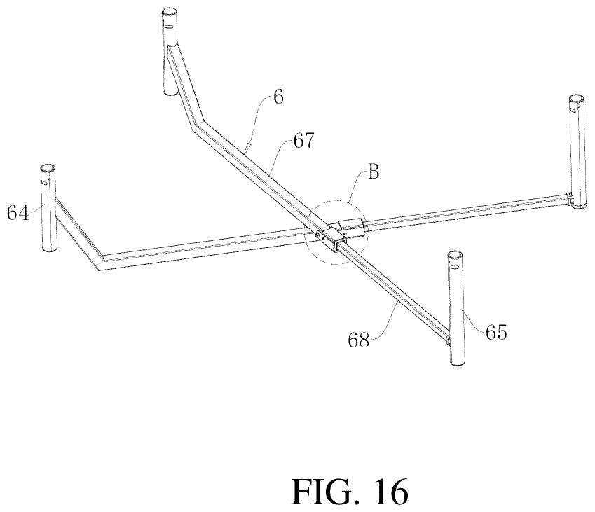

The disclosure is described in further detail below with reference to FIGS. 1-16.

Examples of the disclosure disclose a folding stroller.

### Example 1

Referring to FIG. 1, the folding stroller includes a folding frame and a cloth cover mounted on the folding frame. The folding frame includes a front frame 1, a rear frame 2, a folding mechanism configured for connecting the front frame 1 and the rear frame 2, a set of front wheels 3 mounted to the front frame 1, and a set of rear wheels 4 mounted to the rear frame 2.

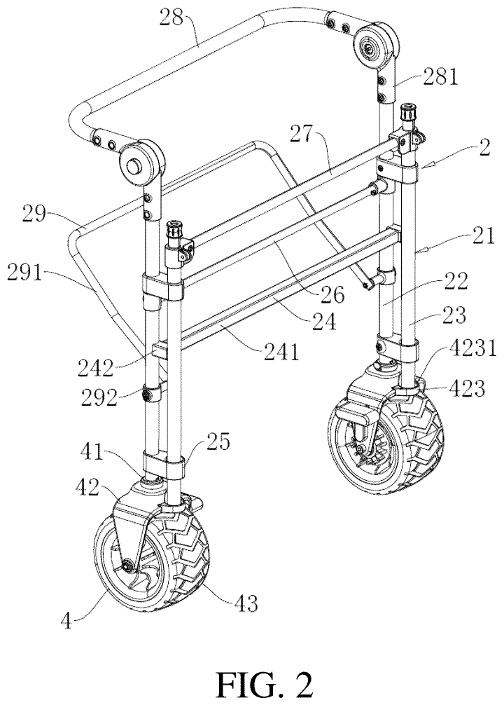

Referring to FIG. 2, the rear frame 2 includes at least two frame units 21 and a reinforcing beam 24 connected to the frame units 21. In the present example, the rear frame 2 has two frame units 21 and is located on the left and right sides of the rear frame 2. The frame unit 21 includes a first upright tube 22, a second upright tube 23 located on the front side of the first upright tube 22, and a locking clamp 25 configured for locking the first upright tube 22 and the second upright tube 23. The first upright tube 22 and the second upright tube 23 are both hollow round metal pipes and are both arranged vertically.

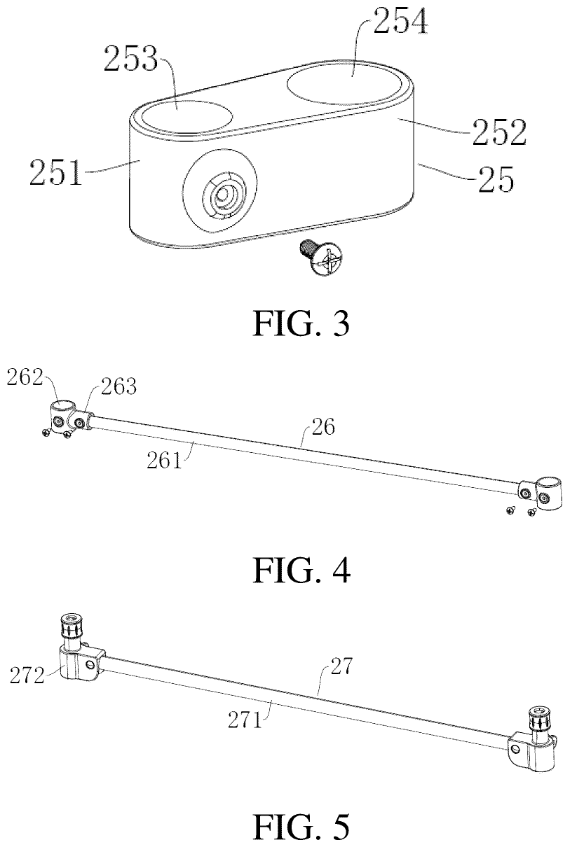

Referring to FIGS. 2 and 3, the locking clamp 25 is a double tube type clamp having a first locking portion 251 configured for cooperating with the first upright tube 22 and a second locking portion 252 configured for cooperating with the second upright tube 23. The first locking portion 251 has a first through hole 253 for arranging the first upright tube 22, and the first locking portion 251 and the first upright tube 22 are locked by means of screws. The second locking portion 252 has a second through hole 254 configured for arranging the second upright tube 23. The second locking portion 252 is not provided with a screw for locking the second upright tube 23, so that the second locking portion 252 is merely sleeved on the second upright tube 23 and does not define the axis of the second upright tube 23, thereby facilitating the assembly between the second upright tube 23 and the locking clamp 25. In the present example, the number of the locking clamps 25 in the frame unit 21 is two, and the two locking clamps 25 are located at the upper and lower portions of the frame unit 21, respectively.

The reinforcing beam 24 includes a main beam 241 and a welding block 242 fixed at both ends of the main beam 241 by welding and adapted to cooperate with the frame unit 21. The welding block 242 is arranged horizontally, and both ends of the welding block 242 have welding arcs for abutting with the first upright tube 22/the second upright tube 23, so that the welding block 242 can better abut with the first upright tube 22/the second upright tube 23. Thus, the welding strength between the welding block 242 and the first upright tube 22/the second upright tube 23 is ideal. The welding block 242 is located between the two locking clamps 25.

Referring to FIGS. 2 and 4, the rear frame 2 is provided with a first reinforcing link rod 26 connected to two first upright tubes 22 and arranged horizontally. The first reinforcing link rod 26 includes a first link rod 261 and two first holders 262 arranged at both ends of the first link rod 261, respectively. The first holder 262 is sleeved outside the first upright tube 22 and secured to the first upright tube 22 by screws. Two of the first holders 262 are provided on opposite sides with a first support sleeve 263 for insertion of the first link rod 261. The first support sleeve 263 and the first link rod 261 are also secured by screws.

Referring to FIGS. 2 and 5, the rear frame 2 is provided with a second reinforcing link rod 27 connected to two second upright tubes 23 and arranged horizontally. The second reinforcing link rod 27 includes a second link rod 271, and two second holders 272 respectively arranged at both ends of the second link rod 271. The second holder 272 is sleeved over the top end of the second upright tube 23 and secured to the second upright tube 23 by screws. The two second holders 272 are provided at opposite sides with arrangement grooves for arranging the second link rods 271, and the second holders 272 and the second link rods 271 are also fixed therebetween by rivets.

The rear frame 2 is provided with a push-pull handle 28 connecting the top ends of the two first upright tubes 22. Both ends of the push-pull handle 28 are provided with a handle sleeve 281 for being sleeved on the top end of the first upright tube 22. The handle sleeve 281 and the top of the first upright tube 22 are secured by two sets of rivet connections.

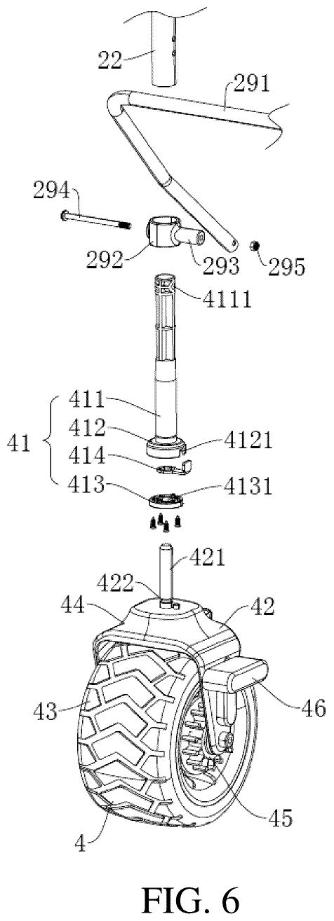

Referring to FIGS. 2 and 6, the rear frame 2 is further provided with an auxiliary handle 29. The auxiliary handle 29 includes a handle tube 291 having an overall U-shape and two handle holders 292 for connecting ends of the handle tube 291. The handle holder 292 is sleeved over the first upright tube 22 and has a support tube 293 extending towards the end of the handle tube 291. The handle holder 292 is provided with a fixing bolt 294 penetrating the handle holder 292 and coaxially fitting with the support tube 293. The fixing bolt 294 is further provided with a fixing nut 295. Here, the end of the handle tube 291 is provided with a through hole through which the end of the fixing bolt 294 passes, and the end of the handle tube 291 is locked to the fixing bolt 294 by the fixing nut 295.

Referring to FIGS. 2 and 6, the rear wheel 4 is a universal wheel and is mounted at the bottom of the first upright tube 22. Here, the axis of rotation of the rear wheel 4 coincides with the axis of the first upright tube 22. The rear wheel 4 includes a connecting base 44 mounted to the rear frame 2, a wheel body 43 rotatably mounted to the connecting base 44, and a brake mechanism configured for restricting rotation of the wheel body 43. The connecting base 44 includes a fixed seat 41 mounted to the first upright tube 22 and a wheel carrier 42 rotatably cooperating with the fixed seat 41. The top of the wheel carrier 42 is provided with a vertically arranged rotary shaft 421. The rotary shaft 421 is provided with a snap-in ring groove 422 in the bottom circumferential direction.

The fixed seat 41 includes a fixing post 411 inserted into the first stand pipe 22, a fixing cover 412 connected to the bottom of the fixing post 411, a fixing cap 413 covering the lower end opening of the fixing cover 412, and a locking member 414 slidably mounted on the fixing cover 412 and used for locking the rotary shaft 421. Here, the top of the fixing post 411 is provided with a bolt through hole 4111 through which the fixing bolt 294 passes. The bottom of the fixing post 411 also has a rotation lumen for the rotation of the rotary shaft 421.

The fixing cap 413 is mounted on the fixing cover 412 by a screw, and a sliding gap for sliding the locking member 414 is formed between the fixing cap 413 and the fixing cover 412. The fixing cap 413 is provided with a fixing opening 4131 penetrating the upper and lower surfaces for insertion of the rotary shaft 421 on the wheel carrier 42, so that the rotary shaft 421 can be inserted into the fixed seat 41.

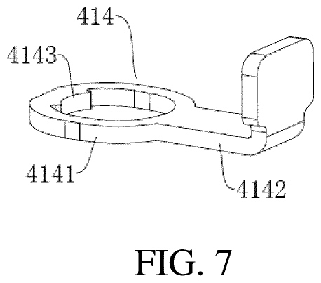

Referring to FIGS. 6 and 7, the locking member 414 includes a snap-in ring piece 4141 capable of being disposed outside the rotary shaft 421 and a tract-pull handle 4142 connected to one side of the snap-in ring piece 4141. A snap-in tab 4143 capable of being snapped into the snap-in ring groove 422 of the rotary shaft 421 is provided along the inner side of the snap-in ring piece 4141. The fixing cover 412 is provided at a side wall with a fixing notch 4121 for extending the tract-pull handle 4142 to the outside of the fixing cover 412. When the rotary shaft 421 is inserted into the fixed seat 41, the pulling handle 4142 can be pulled so that the snap-in tab 4143 is snapped into the snap-in ring groove 422 of the rotary shaft 421, thereby achieving the rotational fit between the wheel carrier 42 and the fixed seat 41 and making the wheel carrier 42 difficult to fall off from the fixed seat 41.

Referring to FIG. 2, the front end of the wheel carrier 42 is provided with a limiting seat 423. The limiting seat 423 is provided with a limiting hole 4231 for inserting the bottom end of the second upright tube 23. The limiting hole 4231 is a circular hole. When the second upright tube 23 is inserted into the limiting hole 4231 of the limiting seat 423, there is a gap between the inner wall of the limiting hole 4231 and the outer wall of the second upright tube 23, so that the rear wheel 4 can perform a small deflection. In the present example, the maximum deflection angle of the rear wheel 4 is not more than ±6°. Here, the maximum deflection angle is not more than ±6°, which means that the rear wheel 4 can rotate at a maximum angle of 6° in the clockwise direction or in the counterclockwise direction when the original state of the rear wheel 4 is the forward state.

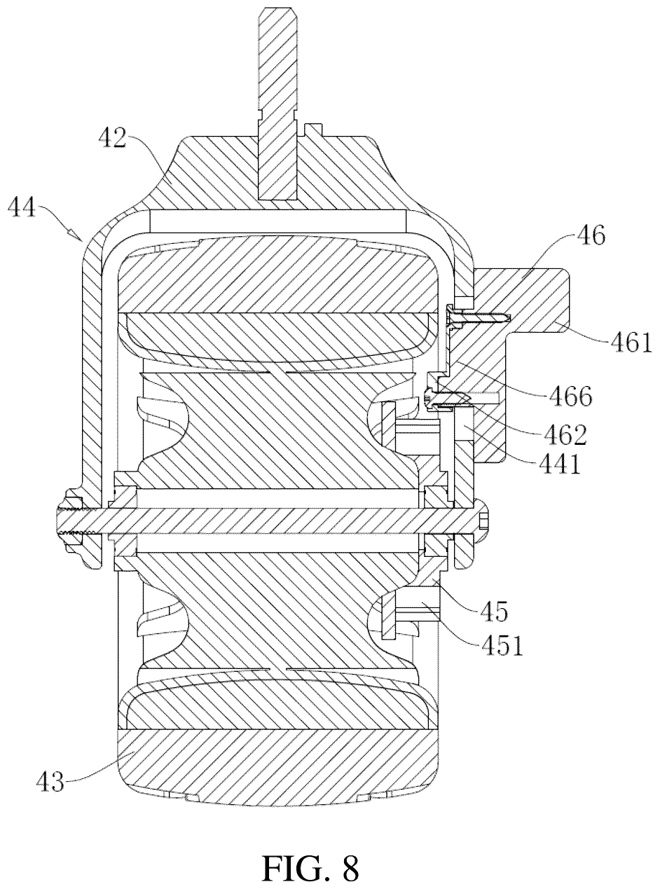

Referring to FIGS. 6 and 8, the brake mechanism includes a brake turntable 45 fixed to the wheel body 43, and a pedal member 46 slidably mounted up and down on the connecting base 44 and adapted to cooperate with the brake turntable 45. The brake turntable 45 has a disc shape and is fixed at a side wall of the wheel body 43. A plurality of brake grooves 451 are circumferentially and uniformly spaced apart from the brake turntable 45.

Referring to FIGS. 6 and 8, the side wall of the wheel carrier 42 has sliding through grooves 441 arranged up and down. The pedal member 46 includes an outer pedal 461 and an inner pedal 462 installed inside the outer pedal 461. Among them, the outer pedal 461 and the inner pedal 462 are locked by screws. The outer pedal 461 has a pedal slider 466 slidably disposed in the sliding through groove 441. The inner pedal 462 has a brake protrusion 463 that can be inserted into the brake groove 451. In order to improve the sliding stability of the pedal member 46 on the wheel carrier 42, the wheel carrier 42 is provided with a slideway along the sliding direction on both sides of the sliding through groove 441, and the pedal member 46 is provided with a sliding bulge cooperating with the slideway. The pedal member 46 is slidably arranged on the wheel carrier 42 and has a braking position and an unlocking position. When the pedal member 46 is in the braking position, the braking projection 463 is inserted into the braking groove 451. When the pedal member 46 is in the unlocking position, the brake projection 463 is located outside the brake turntable 45.

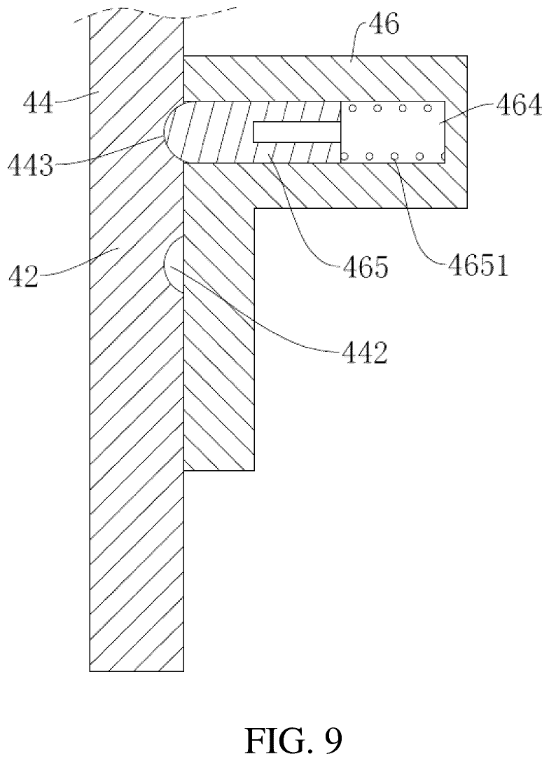

Referring to FIGS. 8 and 9, the positioning structure for positioning the pedal 46 in the braking and unlocking positions is further provided between the pedal 46 and the connecting base 44. The positioning structure includes a positioning hole 464 formed on the pedal member 46, a ball plunger 465 installed in the positioning hole 464, a drive spring 4651 configure for driving the ball plunger 465 to move in the direction of the wheel carrier 42 at all times, a locking groove 442 formed on the wheel carrier 42 and configured for cooperating with the ball plunger 465, and an unlocking groove 443 provided on the wheel carrier 42 and configured for cooperating with the ball plunger 465. The unlocking groove 443 is located on the upper side of the locking groove 442. When the ball plunger 465 is inserted into the locking groove 442, the pedal member 46 is in the braking position. When the ball plunger 465 is inserted into the unlocking groove 443, the pedal member 46 is in the unlocking position.

Referring to FIG. 1, the front frame 1 is a rectangular frame structure including two vertically arranged front upright tubes 11, a front bottom tube 12 welded and fixed to the bottom of the two front upright tubes 11, and a front ejector rod 13 mounted to the top of the two front upright tubes 11. Both ends of the front ejector rod 13 are provided with a front support 14 mounted on the top end of the front upright tube 11. The front mount 14 is fixed to the front upright tube 11 by screws. The two front holders 14 are provided at opposite sides with arrangement grooves for arranging the front ejector rods 13, and the front holders 14 and the front ejector rods 13 are fixed therebetween by rivets.

Referring to FIGS. 1 and 2, the front wheel 3 is a universal wheel and is installed at the bottom of the front upright tube 11. The structure of the front wheel 3 is consistent with the structure of the rear wheel 4 except that the limiting seat 423 is not provided on the wheel carrier 42 and the brake mechanism is not provided. The front frame 1 is fixedly connected with an articulated seat 15 at the front side of the front bottom tube 12, and a trolley handle 16 is rotatably mounted at the articulated seat 15, so that a user can move a folding stroller reinforced with the rear frame 2 forward by means of the trolley handle 16, providing another operation mode of the folding stroller with the reinforced rear frame 2. The number of folding mechanisms provided between the front frame 1 and the rear frame 2 is two groups. The two sets of folding structures are respectively a first folding mechanism 5 and a second folding mechanism 6 located on the lower side of the first folding mechanism 5.

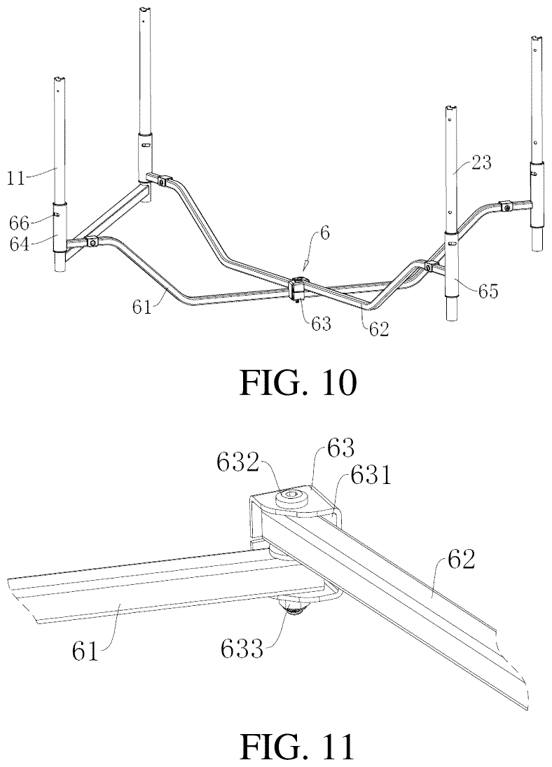

Referring to FIGS. 10 and 11, the second folding mechanism 6 includes two sets of folding link rods arranged opposite to each other on the left and right. The folding link rod is a two-bar folding structure and includes a first folding rod 61 and a second folding rod 62. The end of the first folding rod 61 and the end of the second folding rod 62 are articulated and cooperated by an articulated bracket 63. The articulated bracket 63 has an articulated groove 631 for arranging the end of the first folding rod 61 and the end of the second folding rod 62 stacked up and down, and is provided with a hinge bolt 632 penetrating the articulated bracket 63, the first folding rod 61 and the second folding rod 62. The articulated nut 633 is also provided on the hinge bolt 632.

At the end away from the articulated bracket 63, the first folding rod 61 is connected to the first rotary pipe 64 rotatably sleeved outside the front upright tube 11. The second folding rod 62 is connected at the end away from the articulated bracket 63 with a second rotary tube 65 which is rotatably sleeved outside the second upright tube 23. The folding function of the above-mentioned second folding mechanism 6 is achieved by the horizontal rotation of the first rotary pipe 64 on the front upright tube 11, the ends of the first folding rod 61 and the second folding rod 62 being horizontally articulated, and the horizontal rotation of the second rotary pipe 65 on the second upright tube 23. When the second folding mechanism 6 is in the unfolded state, the two articulated brackets 63 of the two sets of folding link rods abut against each other for limitation.

With reference to FIGS. 1, 12 and 13, the first folding mechanism 5 is of a two-fold rack construction and includes a first turnover frame 51 and a second turnover frame 52 which are articulated and cooperated. The first turnover frame 51 is articulated to the front frame 1 and the second turnover frame 52 is articulated to the rear frame 2. Two ends of one side of the first turnover frame 51 away from the second turnover frame 52 are provided with turnover heads 53 for articulated cooperation with the front upright tube 11. The front upright tube 11 is sleeved with a turnover sleeve 54 for cooperating with the turnover head 53. The turnover sleeve 54 is provided with a first bolt 55 penetrating the turnover sleeve 54 and the front upright tube 11. The turnover head 53 has a through hole for passing the end of the first bolt 55. The first bolt 55 is further provided with a first nut 56 for locking the turnover head 53 to the first bolt 55.

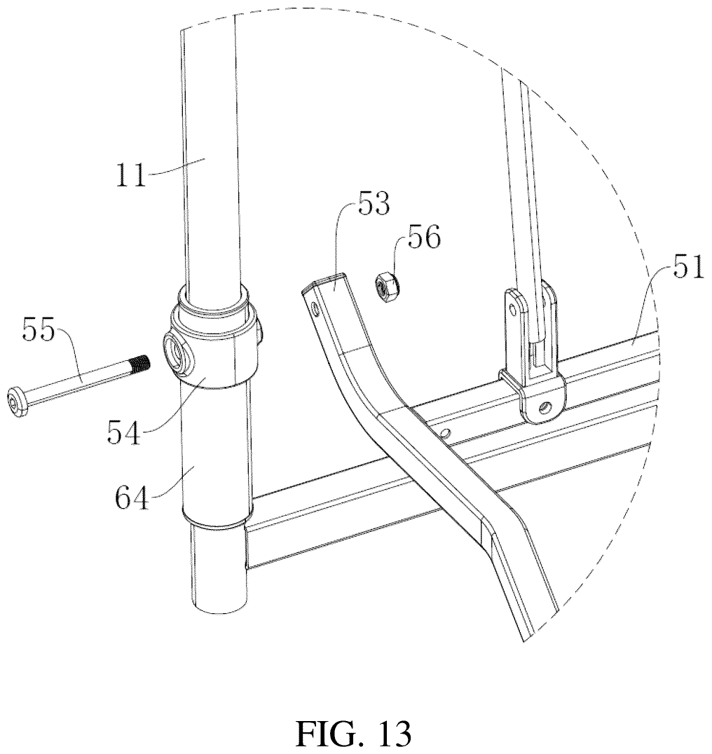

Referring to FIGS. 10 and 13, the turnover sleeve 54 is sleeved over the outside of the first rotary tube 64. In order to avoid interference of the first bolt 55 with the first rotary pipe 64, the first rotary pipe 64 is provided with a first sliding groove for the relative sliding arrangement of the first bolt 55.

Referring to FIG. 1, FIG. 6 and FIG. 13, the first bolt 55 is also cooperated with the bolt through hole 4111 of the fixing post 411 of the front wheel 3. The articulated-coupled structure of the second turnover frame 52 with the rear frame 2 and the articulated-coupled structure of the first turnover frame 51 with the front frame 1 are identical and will not be described in detail herein.

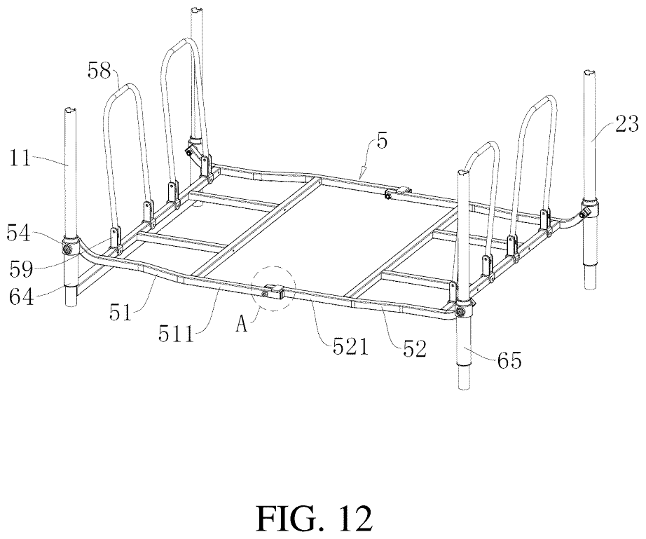

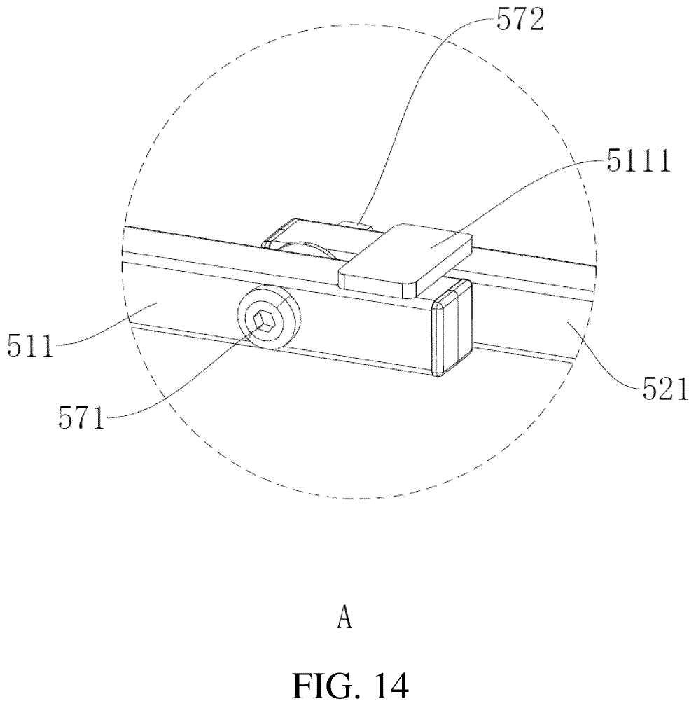

Referring to FIGS. 12 and 14, both ends of one side of the first turnover frame 51 facing towards the second turnover frame 52 are provided with a first side bar 511, and both sides of the second turnover frame 52 are provided with a second side bar 521 arranged corresponding to the first side bar 511. The first side bar 511 and the second side bar 521 are connected and fixed by an overturning bolt 571 and an overturning nut 572, so that the first side bar 511 and the second side bar 521 can rotate relative to each other and the axis of rotation 421 is horizontal. The first side bar 511 is provided with a limiting lug 5111 for limiting the overturning of the second side bar 521. When the end of the first side bar 511 abuts against the limiting lug 5111, both the first and second turnover frames 51, 52 are horizontally arranged.

Referring to FIGS. 12 and 13, the first and second turnover frames 51 and 52 are rotatably installed at opposite sides thereof with an overturning bracket 58 for supporting the inside of the cloth cover. The first and second turnover frames 51 and 52 are each provided with an overturning holder 59 for rotatably arranging the overturning bracket 58. The overturning brackets 58 are inverted U-shaped pipe racks, and each overturning bracket 58 corresponds to two overturning holders 59. The lower portion of the overturning holder 59 is fixed to the first/second turnover frames 51/52 by a screw, and the overturning bracket 58 is rotatably mounted to the upper portion of the overturning holder 59 by a bolt-and-nut structure. In the present example, the first turnover frame 51 and the second turnover frame 52 are provided with two sets of overturning brackets 58.

With reference to FIGS. 1-14, an implementation principle of the folding stroller according to an example of the disclosure is as follows. The above-mentioned folding stroller with the reinforced rear frame 2 is provided with a braking structure at the rear wheel 4, which is different from a traditional abutting and locking structure. The braking structure cooperates with the braking groove 451 of the braking turntable 45 via the brake projection 463 so as to lock the rear wheel 4, so that the wheel body 43 of the rear wheel 4 does not rotate. The reliability of the above-mentioned braking structure is ideal and the braking effect is ideal. Furthermore, by arranging the rear frame 2 to include two frame units 21, a reinforcing beam 24 connecting the two frame units 21, a first reinforcing link rod 26 and a second reinforcing link rod 27, the rear frame 2 forms a spatial three-dimensional frame structure, and the probability of deformation of the rear frame 2 of the folding stroller during transportation of the load goods is reduced.

### Example 2

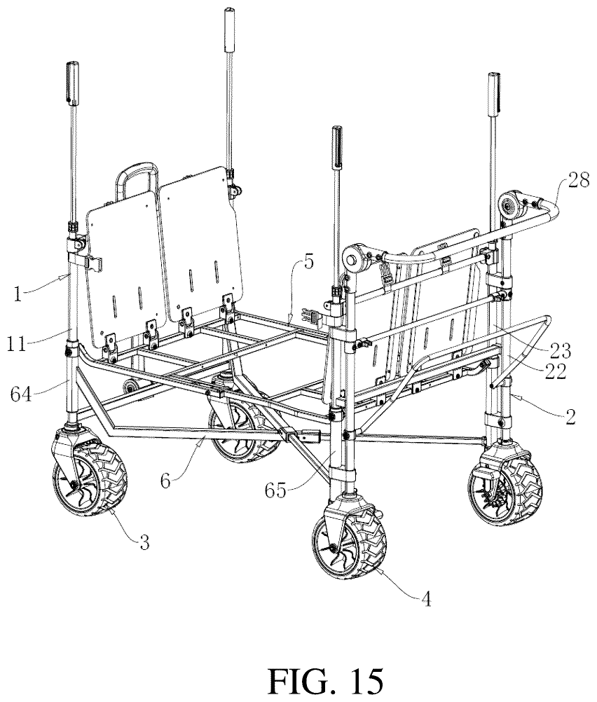

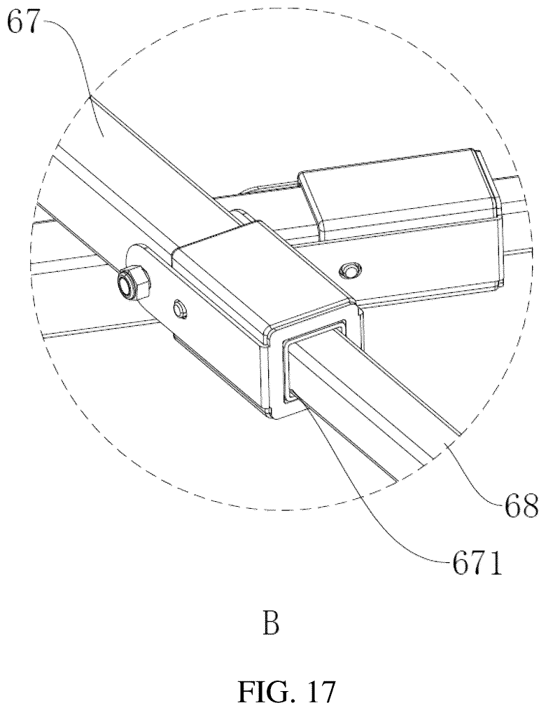

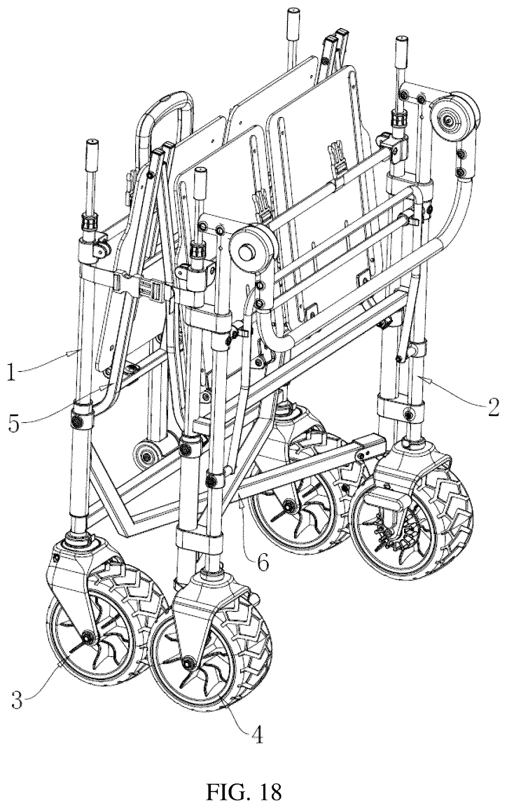

Referring to FIGS. 15 to 18, the folding stroller according to the example of the disclosure has the same structure as that of the folding stroller according to the Example 1 except that the second folding mechanism 6 is different from that of Example 1.

The second folding mechanism 6 in this example includes two sets of telescopic link rods arranged opposite to each other. The telescopic link rod includes a first telescopic link rod 67 and a second telescopic link rod 68 slidably mounted to an end of the first telescopic link rod 67. The end of the first telescopic link rod 67 has an extend-retract hole 671 for slidably arranging the second telescopic link rod 68. The first telescopic link rod 67 is connected at an end away from the second telescopic link rod 68 to the first rotary pipe 64 rotatably sleeved outside the front upright tube 11. The second telescopic link rod 68 is connected at an end away from the first telescopic link rod to the second rotary tube 65 which is rotatably sleeved outside the second upright tube 23. The above-mentioned folding function of the second folding mechanism 6 is achieved by the horizontal rotation of the first rotary pipe 64 on the front upright tube 11, the plug-in cooperation of the first telescopic link rod 67 and the second telescopic link rod 68, and the horizontal rotation of the second rotary pipe 65 on the second upright tube 23.

1. A folding stroller comprising a front frame (1), a rear frame (2), a folding mechanism configured for connecting the front frame (1) and the rear frame (2), a set of front wheels (3) mounted to the front frame (1) and a set of rear wheels (4) mounted to the rear frame (2), wherein the rear wheel (4) includes a connecting base (44) mounted to the rear frame (2), a wheel body (43) rotatably mounted to the connecting base (44), and a brake mechanism configured for restricting rotation of the wheel body (43); the brake mechanism comprises a brake turntable (45) fixed to the wheel body (43), and a pedal member (46) slidably mounted up and down on the connecting base (44) and configured for cooperating with the brake turntable (45); a plurality of brake grooves (451) are circumferentially spaced apart from the brake turntable (45); the pedal member (46) has a brake projection (463) inserted into the brake groove (451); the pedal member (46) is slidably mounted up and down on the connecting base (44) and has a braking position and an unlocking position;
the brake projection (463) is inserted into the brake groove (451) when the pedal member (46) is in a braking position; and the brake projection (463) is located outside the brake turntable (45) when the pedal member (46) is in the unlocking position.

2. The folding stroller according to claim 1, wherein a positioning structure configured for positioning the pedal member (46) in the braking position and the unlocking position is further provided between the pedal member (46) and the connecting base (44); the positioning structure comprises a positioning hole (464) formed on the pedal member (46), a ball plunger (465) mounted in the positioning hole (464), and a drive spring (4651) configured for driving the ball plunger (465) to move in the direction of the connecting base (44) at all times, a locking groove (442) formed on the connecting base (44) and configured for cooperating with the ball plunger (465), and an unlocking groove (443) formed on the connecting base (44) and configured for cooperating with the ball plunger (465); the pedal member (46) is in the braking position when the ball plunger (465) is inserted into the locking groove (442); and the pedal member (46) is in the unlocking position when the ball plunger (465) is inserted into the unlocking groove (443).

3. The folding stroller according to claim 1, wherein the connecting base (44) has sliding through grooves (441) arranged up and down; the pedal member (46) includes an outer pedal (461) and an inner pedal (462) mounted inside the outer pedal (461); the outer pedal (461) has a pedal slider (466) slidably arranged in the sliding through groove (441); and the brake projection (463) is arranged on the inner pedal (462).

4. The folding stroller according to claim 1, wherein the rear frame (2) comprises at least two frame units (21) and a reinforcing beam (24) connected to the frame units (21); the frame unit (21) comprises a first upright tube (22), a second upright tube (23) located on a front side of the first upright tube (22), and a locking clamp (25) configured for locking the first upright tube (22) and the second upright tube (23); the reinforcing beam (24) has a welding block (242) corresponding to the frame unit (21) and configured for connecting and fixing the first upright tube (22) and the second upright tube (23), the welding block (242) being located between the first upright tube (22) and the second upright tube (23); the locking clamp (25) is arranged on both upper and lower sides of the welding block (242); the locking clamp (25) comprises a first locking portion (251) and a second locking portion (252); the first locking portion (251) has a first through hole (253) configured for arranging the first upright tube (22), and the first locking portion (251) and the first upright tube (22) are locked by screws; and the second locking portion (252) has a second through hole (254) configured for arranging the second upright tube (23).

5. The folding stroller according to claim 4, wherein the first upright tubes (22) are each provided with a first holder (262), and a first link rod (261) being connected between adjacent first holders (262); and the second upright tubes (23) are each provided with a second holder (272), and a second link rod (271) is connected between adjacent second holders (272).

6. The folding stroller according to claim 4, wherein the number of the frame units (21) in the rear frame (2) is two, two of the frame units (21) being located on both sides of the rear frame (2); and
the rear wheel (4) is mounted to a bottom end of the first upright tube (22).

7. The folding stroller according to claim 4, wherein the connecting base (44) comprises a fixed seat (41) mounted to the first upright tube (22) and a wheel carrier (42) rotatably cooperating with the fixed seat (41); a limiting seat (423) is provided at a front end of the wheel carrier (42), and the limiting seat (423) is provided with a limiting hole (4231) for inserting the second upright tube (23); a gap exists between the inner wall of the limiting hole (4231) and the outer wall of the second upright tube (23); and the maximum deflection angle of the rear wheel (4) is not greater than ±6°.

8. The folding stroller according to claim 7, wherein the rear frame (2) is further provided with a push-pull handle (28), both ends of which are provided with a handle sleeve (281) arranged corresponding to the first upright tube (22); and the handle sleeve (281) is sleeved on a top end of the corresponding first upright tube (22).

9. The folding stroller according to claim 1, wherein the number of folding mechanisms provided between the front frame (1) and the rear frame (2) is two groups, which are a first folding mechanism (5) and a second folding mechanism (6) located on a lower side of the first folding mechanism (5), respectively; and an overturning bracket (58) configured for supporting the inside of the cloth cover is rotatably mounted on both sides of the first folding mechanism (5).

10. The folding stroller according to claim 9, wherein the first folding mechanism (5) comprises a first turnover frame (51) and a second turnover frame (52) which is turnover and folded up and down in cooperation; one end of the first turnover frame (51) is turnover and folded up and down and mounted to the front frame (1); and the second turnover frame is turnover and folded up and down and mounted to the rear frame (2).

11. The folding stroller according to claim 9, wherein the second folding mechanism (6) comprises two sets of folding link rods arranged opposite to each other in a left and right direction; the folding link rods comprises a first folding rod (61), a second folding rod (62) and an articulated frame (63), one end of the first folding rod (61) being rotatably mounted on the front frame (1) and the other end being articulated to the articulated frame (63); and one end of the second folding rod (62) is rotatably mounted on the rear frame (2) and the other end is articulated to the articulated frame (63).

12. The folding stroller according to claim 9, wherein the second folding mechanism (6) comprises two sets of telescopic link rods arranged opposite to each other in the left and right direction, the telescopic link rods comprising a first telescopic link rod and a second telescopic link rod (68);
one end of the first telescopic link rod is rotatably mounted on the front frame (1), and the other end has a telescopic hole (671) into which the second telescopic link rod (68) extends; and one end of the second telescopic link rod (68) facing away from the first telescopic link rod is rotatably mounted on the rear frame (2).
